(19) United States
(12) Patent Application Publication
(10) Pub. No.: US 2022/0167704 A1
(43) Pub. Date: Jun. 2, 2022

(54) NEAR FIELD COMMUNICATIONS ENABLED BUCKLE FOR HELMET, SYSTEM AND METHOD OF USING THE SAME

(71) Applicant: Antonio Jose Guillen Bayarri, Puzol (ES)

(72) Inventor: Antonio Jose Guillen Bayarri, Puzol (ES)

(21) Appl. No.: 17/247,083

(22) Filed: Nov. 30, 2020

(51) Int. Cl. A42B 3/30; H04B 5/00; A42B 3/08

(52) U.S. Cl. CPC A42B 3/30; A42B 3/08; H04B 5/0025

(57) ABSTRACT

A near field communications (NFC) enabled buckle for helmet and method of using the same are disclosed. A first coupling end and a second coupling end are configured for releasable cooperative joining of the ends. An NFC chip is carried by one of the first coupling end and the second coupling end. The NFC chip is configured to couple to an NFC enabled communications device. The user may register the NFC chip with a tracking and alert system. An app allows the user to program the NFC chip with one or more of identification data, medical data, and emergency notification data. In the event the rider is involved in an accident, a first responder may read the data on the NFC chip and use the encoded data to render assistance. An app allows user activation of an SOS by tapping their NFC enabled communications device on the NFC enabled buckle.

### BACKGROUND OF THE INVENTION

The present invention relates to helmet restraint systems, and more particularly to buckles for helmet restraint systems.

Near Field Communications technology is commonly used for smartphones and credit cards, ideal for contactless energy and data transfer, and close-range sharing between devices.

Few other helmets utilize the NFC technology. The few that do place the chip within the structure of the helmet shell. This can be problematic, as the location of the chip must be precise to easily connect with an NFC enabled communications device, such as a smart phone in an emergency. The NFC chip must be in an easily identifiable location on the helmet and be unencumbered by layers of padding which can affect the connection of the NFC chip with the NFC enabled communications device.

As can be seen, there is a need for an improved helmet restraint system.

### SUMMARY OF THE INVENTION

In one aspect of the present invention, a buckle assembly for a helmet is disclosed. The buckle assembly includes a first coupling end and a second coupling end configured to releasably and cooperatively join together. Each of the first coupling end and the second coupling end are configured to attach to a shell of the helmet via a chinstrap. A near field communications (NFC) chip is carried by one of the first coupling end and the second coupling end.

In some embodiments, a recess is defined in one of the first coupling end and the second coupling end configured to carry the NFC chip. A removable access cover may be proved to cover the recess. The removable access cover permits a removal and an insertion of the NFC chip in the recess.

In other embodiments, a quick release strap is coupled to a distal end of the second coupling end. The quick release strap is operable to release the cooperative joining of the first coupling end and the second coupling end.

In other aspects of the invention, a buckle assembly for a helmet includes a first coupling end and a second coupling end configured to releasably and cooperatively join together. Each of the first coupling end and the second coupling end are configured to attach to a shell of the helmet via a chinstrap. A recess in one of the first coupling end and the second coupling end is configured to carry a near field communications (NFC) chip.

In some embodiments, an NFC chip is carried in the recess. In other embodiments, a removable access cover is provided to cover the recess.

In other embodiments, a quick release strap is coupled to a distal end of the second coupling end. The quick release strap is operable to release the cooperative joining of the first coupling end and the second coupling end.

In yet other embodiments, a connection on each of the first coupling end and the second coupling end are configured to attach to a distal end of a chinstrap, the chinstrap having a proximal end connection to the helmet.

In yet other aspects of the invention, a helmet is disclosed. The helmet includes an outer shell. A chinstrap having a proximal end is coupled to the outer shell and a distal end connected to each of a first coupling end and a second coupling end of a buckle assembly. The first coupling end and the second coupling end are configured for releasable cooperative engagement to secure the buckle assembly in a closed condition. A near field communication (NFC) chip is carried by one of the first coupling end or the second coupling end.

In some embodiments, a recess is defined in one of the first coupling end and the second coupling end configured to carry the NFC chip. A removable access cover may be provided to cover the recess. The removable access cover permits a removal and an insertion of the NFC chip.

These and other features, aspects and advantages of the present invention will become better understood with reference to the following drawings, description and claims.

### BRIEF DESCRIPTION OF THE DRAWINGS

FIG. 1 is a top plan view of a micro metric quick release buckle.

FIG. 2 is a top plan view of an Near Field Communications (NFC) chip.

FIG. 3 is a top plan view of the micro metric quick release buckle with embedded NFC chip component exposed.

FIG. 4 is a perspective view of the micro metric quick release buckle showing the embedded NFC chip component.

FIG. 5 is a schematic diagram of Data and Energy Transfer between the NFC Chip and an NFC Enabled Device.

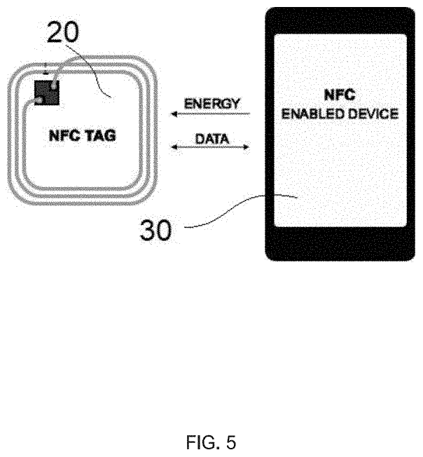

FIG. 6 is a method of registering the NFC chip with an alert and monitoring system.

FIG. 7 is a diagram illustrating a representative use of the NFC enabled helmet band.

FIG. 8 is a diagram illustrating a second representative use of the NFC enabled helmet band.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides an improved helmet retaining buckle that is provisioned with a near field communications (NFC) chip. The NFC chip may be utilized in a monitoring and alert system to track a condition of the wearer of the helmet.

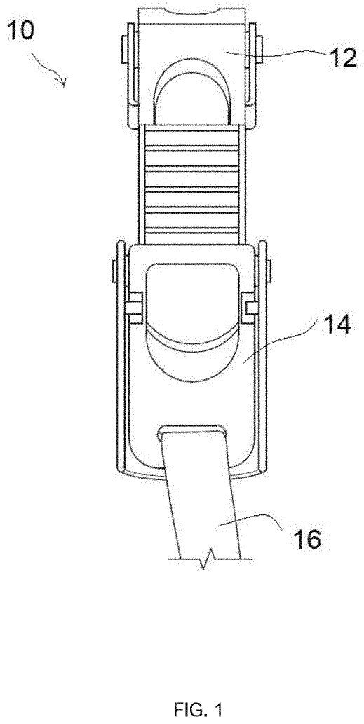

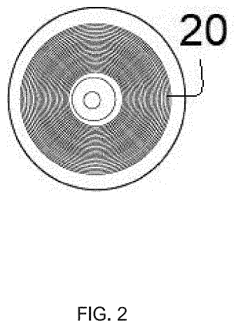

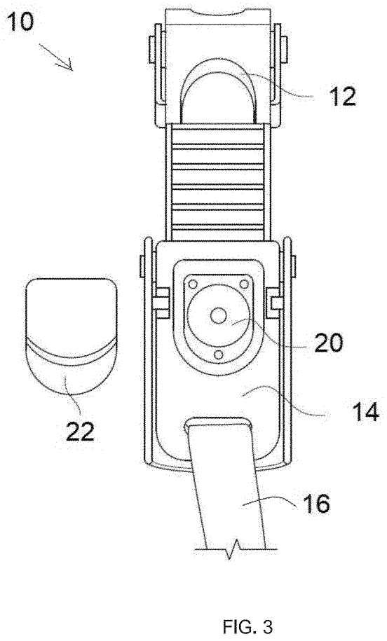

As seen in the drawings of FIGS. 1-4, an NFC enabled buckle 10 is shown. The NFC enabled buckle 10 includes a first coupling end 12 and a second coupling end 14 that cooperatively join together. In a preferred embodiment, the NFC enabled buckle 10 is a quick release buckle, having a pull 16 extending from a distal end of the second coupling end 14 to release the cooperative engagement of the first coupling end 12 and the second coupling end. A chinstrap 18 has a proximal end and a distal end. A distal end of the chinstrap 18 attaches to each of the first coupling end 12 and the second coupling end 14. The proximal end of the chinstrap 18 is attached to a shell of a helmet 40.

By integrating the NFC chip 20 into the quick release buckle 10, the NFC chip 20 is protected in a hard, plastic casing giving it extra durability. The plastic shell will provide protection from extreme heat and cold, preventing water damage, as well as impact loads. Additionally, the main body of the buckle 10 may be colored a bright blue color making it clearly visible and identifiable in the event of an emergency.

In the non-limiting embodiment shown, the helmet 40 is a motorcycle helmet. The choice of the micrometric quick release buckle 10 for use in this design is due to its secure and straightforward system for adjusting and fixing the helmet 40 in position on the rider's head. This buckle 10 can be safely released and operated with one hand, even wearing gloves, which may be crucial for experienced riders.

As will be appreciated from the present disclosure, aspects of the present invention may find broader applicability and be suitable for bicyclists, rafters, rock climbing, law enforcement, military, and any number of other situations where the wearer of the helmet may find themselves in need of monitoring and assistance.

An NFC chip 20 may be embedded within one off the first coupling end 12 or the second coupling end 14. Preferably, the NFC chip 20 is received within an enclosure defined within the buckle assembly 10. An access cover 22 may be provided to remove or replace the NFC chip 20 as needed.

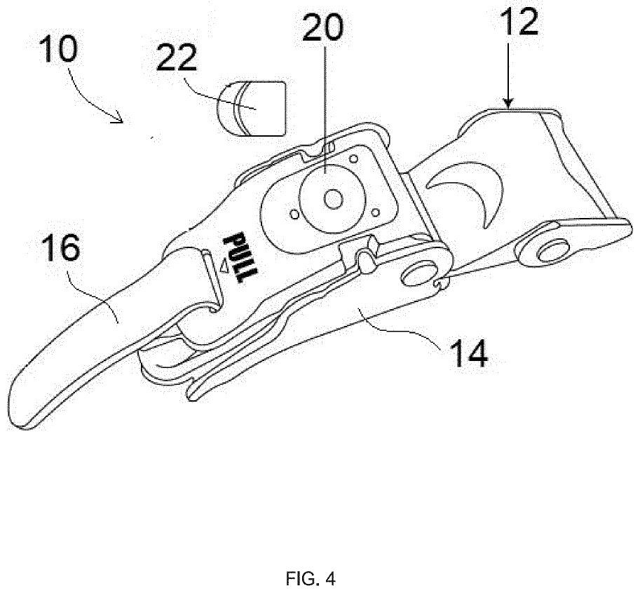

As seen in FIG. 4, the NFC chip 20 is shown in communication with an NFC enable communications device 30, such as a smart phone, tablet, a scanner, or the like. The NFC chip 20 may measure on the order of about 9 mm in diameter, is enclosed within the buckle assembly 10, as previously described. The NFC chip 20 may have an operating frequency in the range of about 13.56 MHZ.

The user can connect the NFC chip 20 to their NFC enabled communications device 30, by enabling the NFC function on their smartphone and tapping the phone 30 in close proximity to the NFC enabled buckle 10. With an NFC chip 20, no device pairing is required between the NFC enabled buckle 10 and the phone 30, and detection is instantaneous, making the process fast and simple for the user. If the rider wants to connect the NFC chip 20 while in motion, it is much safer to tap the NFC enabled communications device 30 on the chinstrap QRB buckle 10 than to search blindly for a spot on the helmet shell 40.

In certain embodiments, the NFC chip 20 has at least a 144 bit capacity. The NFC chip 20 can hold personal, medical, and contact information, as well as be set up to connect immediately to certain apps in the NFC enabled communications device 30. The memory can also be segmented to implement multiple applications at the same time. With an NFC chip 20 life of at least 100,000 erasures, the user can edit and change the information and settings of the NFC chip 20 as often as they want. The NFC chip 20 may also have a 32-bit password protection to prevent unauthorized memory operations, so the user can choose to password protect their data, the setup is completely customizable to each user's needs and preferences and may be accomplished through an app running on the NFC enabled communications device 30.

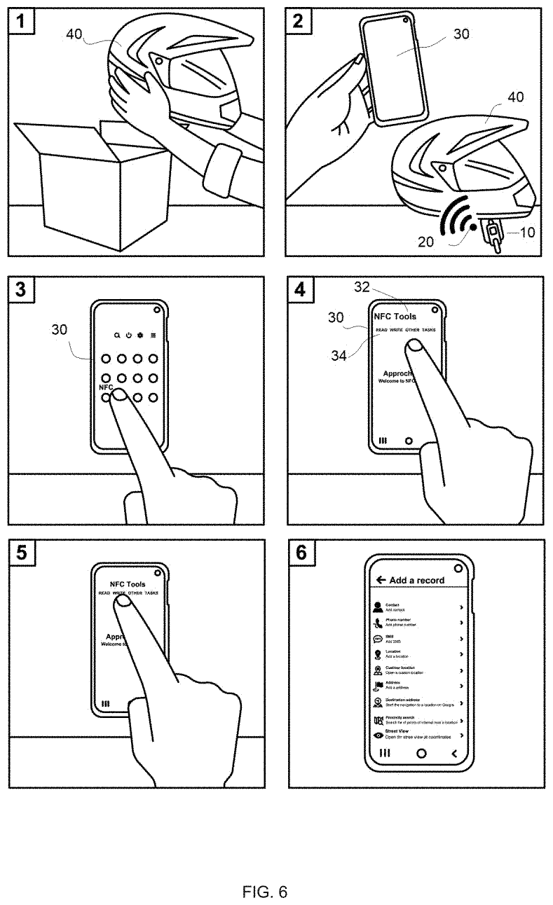

As seen in FIGS. 6-8, the NFC enabled buckle 10 may be supported with a variety of software apps to sync the user's information, should he or she chose to. In one embodiment, an app integrates with emergency systems in more than 50 countries and allows the user, a medic, or anyone in an emergency situation to contact the system and have support to identify any critical information that may help to save a life.

A representative registration process is shown in FIG. 6. When the user receives a helmet 40 or a buckle assembly 10 for installation with their helmet 40, the user enables communication on their NFC enabled communications device 30. The device 30 then reads the NFC chip 20 and may then be registered with the system. The registration allows users to store more data, going over the NFC chip storage limit and link it to the unique identifier of the NFC chip 20 carried by the buckle 10. Through an NFC tools menu 32 on the app, the user has access to the site and can modify, enhance, or delete any data associated to him or her and their helmet 40 by various controls 32. A mobile app version may be available for Android and iPhone smartphones with a simplified and direct access to this database.

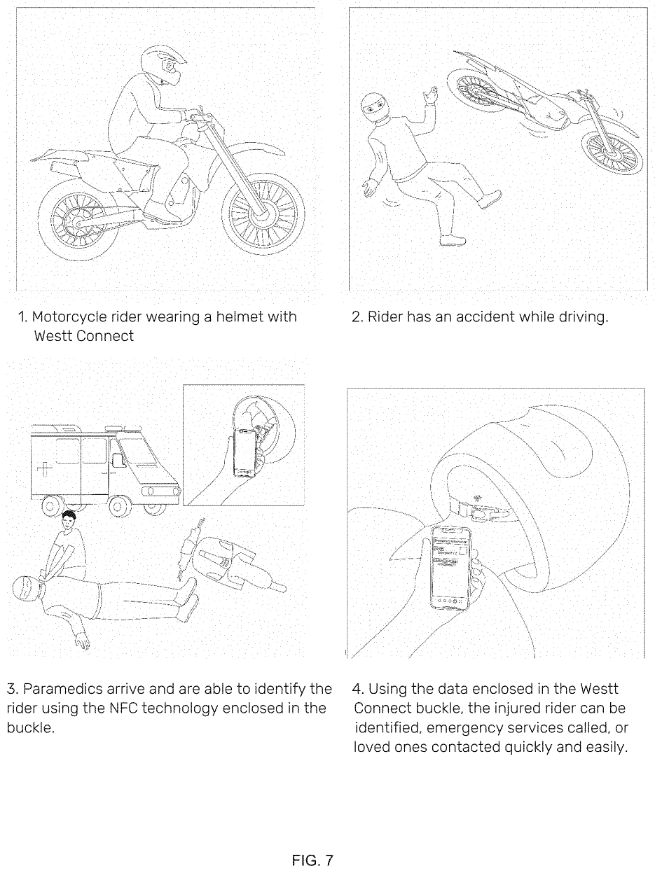

A sample use of the app and NFC enabled buckle 10 according to aspects of the invention is shown in FIG. 7. The user has their helmet 40 with NFC enabled buckle 10 registered with the system and saves relevant information on the system. If the rider has an accident that may incapacitate the rider, a first responder may utilize an NFC enabled communications device 30 to scan the rider's NFC chip 20.

When registered as a medical or emergency services user with the system, the first responder can access information that the rider has elected to save with the system. If provided by the rider, the first responder may be able to access the rider's identity, vital medical information, or emergency contact information for the first responder to notify in the event of an accident. By locating the NFC chip 20 on the buckle 10 the first responder can avoid unnecessary movement of the rider in search of a wallet or other identification. The first responder can also obtain the data without removing the rider's helmet 40.

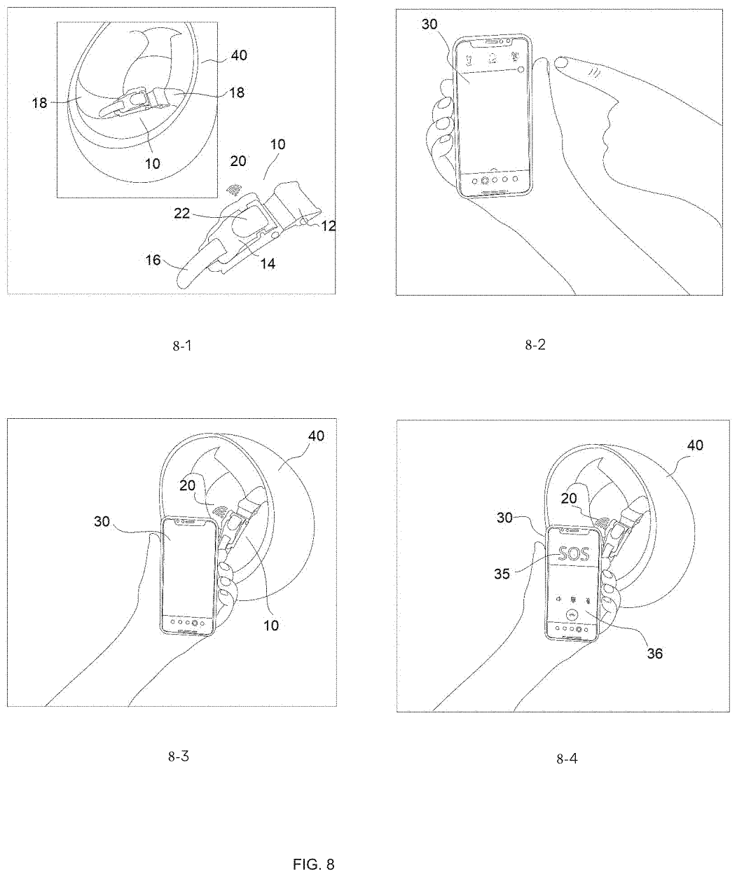

In another representative use of the NFC enabled buckle 10 shown in FIG. 8, the rider may also use the NFC chip 20 to activate a call for help. In this instance, the rider uses their own NFC enabled communications device 30 to activate an SOS sequence to alert local emergency services. The SOS may also access the user's global positioning system (GPS) or other location data from their NFC enabled communications device 30 to automatically provide the rider's location to assistance. While shown with the helmet 40 removed, a disabled rider may also use the alert app to summon assistance. A large SOS control 35 is presented in the display of the device 30 so that the rider may execute the control 35 in the event of blurred or obstructed vision. The SOS app may be activated by the user tapping the device 30 a predetermined, or user configurable number of times. The SOS app may also provide acceleration, and other movement data recorded on one or more sensors of the NFC enabled device 30 to alert first responders of the nature of the incident to which they are being called. Likewise, the SOS app may also be configured to activate on sensing a crash sequence by the accelerometer or one or more other sensors of the NFC enabled device 30.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A buckle assembly for a helmet, comprising:
a first coupling end and a second coupling end configured to releasably and cooperatively join, each of the first coupling end and the second coupling end configured to attach to a shell of the helmet via a chinstrap; and
a near field communications (NFC) chip carried by one of the first coupling end and the second coupling end.

2. The buckle assembly of claim 1, further comprising:
a recess in one of the first coupling end and the second coupling end configured to carry the NFC chip.

3. The buckle assembly of claim 2, further comprising:
a removable access cover to cover the recess.

4. The buckle assembly of claim 3, wherein the removable access cover permits a removal and an insertion of the NFC chip.

5. The buckle assembly of claim 1, further comprising:
a quick release strap coupled to a distal end of the second coupling end, the quick release strap operable to release the cooperative joining of the first coupling end and the second coupling end.

6. A buckle assembly for a helmet, comprising:
a first coupling end and a second coupling end configured to releasably and cooperatively join, each of the first coupling end and the second coupling end configured to attach to a shell of the helmet via a chinstrap; and
a recess in one of the first coupling end and the second coupling end configured to carry a near field communications (NFC) chip.

7. The buckle assembly of claim 6, further comprising:
an NFC chip carried in the recess.

8. The buckle assembly of claim 7, further comprising:
a removable access cover to cover the recess.

9. The buckle assembly of claim 6, further comprising:
a quick release strap coupled to a distal end of the second coupling end, the quick release strap operable to release the cooperative joining of the first coupling end and the second coupling end.

10. The buckle assembly of claim 6, further comprising:
a connection on each of the first coupling end and the second coupling end configured to attach to a distal end of a chinstrap, the chinstrap having a proximal end connection to the helmet.

11. A helmet comprising:
an outer shell;
a chinstrap having a proximal end coupled to the outer shell and a distal end connected to each of a first coupling end and a second coupling end of a buckle assembly,
the first coupling end and the second coupling end configured for releasable cooperative engagement to secure the buckle assembly in a closed condition; and
a near field communication (NFC) chip carried by one of the first coupling end or the second coupling end.

12. The helmet claim 11, further comprising:
a recess in one of the first coupling end and the second coupling end configured to carry the NFC chip.

13. The buckle assembly of claim 12, further comprising:
a removable access cover to cover the recess.

14. The buckle assembly of claim 13, wherein the removable access cover permits a removal and an insertion of the NFC chip.
